(19) United States
(12) Patent Application Publication
(10) Pub. No.: US 2024/0430295 A1
(43) Pub. Date: Dec. 26, 2024

(54) DYNAMIC AND AUTOMATIC PLAYBOOK GENERATION USING CONTEXTUAL NETWORK RESPONSES

(71) Applicant: INTERNATIONAL BUSINESS MACHINES CORPORATION, ARMONK, NY (US)

(72) Inventors: Dusty Boshoff, JOHANNESBURG (ZA); Diane Chalmers, Rochester, MN (US)

(73) Assignee: INTERNATIONAL BUSINESS MACHINES CORPORATION, ARMONK, NY (US)

(21) Appl. No.: 18/212,928

(22) Filed: Jun. 22, 2023

(51) Int. Cl. H04L 9/40

(52) U.S. Cl. CPC H04L 63/1441; H04L 63/205

(57) ABSTRACT

An approach is provided for dynamically and automatically generating a playbook. A new incident and the tactics, techniques, and procedures (TTP) specifying the new incident are identified. The TTP are mapped to actions included in a TTP-based response matrix, which associates actions that address security incidents with respective TTPs that specify the security incidents. The actions are mapped to technologies in a defense capabilities matrix, which associates technologies deployed by an organization with multiple countermeasures to security incidents. A playbook is automatically generated that specifies countermeasure(s) to counter the new incident. The countermeasure(s) are based on the actions, the technologies to which the actions are mapped, and the TTP mapped to the actions. The countermeasure(s) are executed by using the defense capabilities matrix.

### BACKGROUND

The present invention relates to incident response in cybersecurity, and more particularly to dynamically and automatically generating and automating incident response playbooks.

Security Orchestration, Automation and Response (SOAR) is a collection of software applications that enables an organization to obtain information about cybersecurity threats and respond to computer security incidents. Cybersecurity threats are divided into different classifications called incident types. Some incident types, such as ransomware, distributed denial of service (DDOS) attack, etc. require more tooling and techniques to stop and eradicate than other types. A cyber threat can be addressed in a Security Operations Center (SOC) through mechanisms such as response procedures (also known as playbooks) that describe to an analyst the exact steps to take to respond to each unique threat. Playbooks are customized to handle a variety of cyber threats, such as phishing, malware infection, violation of security policies, denial of service attack, and ransomware.

### SUMMARY

In one embodiment, the present invention provides a computer system that includes one or more computer processors, one or more computer readable storage media, and computer readable code stored collectively in the one or more computer readable storage media. The computer readable code includes data and instructions to cause the one or more computer processors to perform operations. The operations include identifying a new incident and the tactics, techniques, and procedures (TTP) that specify the new incident. The operations further include mapping the TTP to actions included in a TTP-based response matrix. The TTP-based response matrix associates a plurality of actions with respective TTPs that specify security incidents. The plurality of actions is required to address the security incidents. The operations further include mapping the actions to technologies included in a defense capabilities matrix. The defense capabilities matrix associates a plurality of technologies deployed in a network by an organization with a plurality of countermeasures. The operations further include automatically generating a playbook that specifies one or more countermeasures to counter the new incident. The one or more countermeasures are based on the actions, the technologies to which the actions are mapped, and the TTP mapped to the actions. The operations further include executing the one or more countermeasures by using the defense capabilities matrix.

A computer program product and a method corresponding to the above-summarized computer system are also described and claimed herein.

### BRIEF DESCRIPTION OF THE DRAWINGS

FIG. 1 is a block diagram of a system for dynamic and automatic playbook generation, in accordance with embodiments of the present invention.

FIG. 2 is a block diagram of modules included in code included in the system of FIG. 1, in accordance with embodiments of the present invention.

FIG. 3 is a flowchart of a process of dynamic and automatic playbook generation, where operations of the flowchart are performed by the modules in FIG. 2, in accordance with embodiments of the present invention.

FIG. 4 is a block diagram of a system that implements the process of FIG. 3, in accordance with embodiments of the present invention.

FIG. 5 is an example of the system of FIG. 4 implementing the process of FIG. 3, in accordance with embodiments of the present invention.

### DETAILED DESCRIPTION

### Overview

Response procedures for responding to a computer security incident require a large number of labor hours and skills to define, implement, and keep updated. The amount of time to develop a response procedure is often negatively affected by deficiencies in the development skill available and the understanding of available features of the relevant technologies. Some key aspects of successful playbooks require integration points for automation and speed of execution; however, in many organizations, time plays against the defenders and the landscape is not fully understood or utilized in the event of a cyber threat. In most cases, skills to handle a cyber threat are very difficult to acquire. Important response procedures are unknown, forgotten, or descoped due to a lack of technical understanding (e.g., ransomware response procedures are missed due to a lack of detection and integration and response understanding). Moreover, existing techniques for addressing cyber threats fail to use important information available to a Security, Orchestration, Automation and Response (SOAR) platform.

A computer security incident is also referred to herein as a security incident or simply as an incident. As used herein, an incident or new incident is defined as an occurrence that actually or potentially jeopardizes, without lawful authority, the confidentiality, integrity, or availability of an information system or the information that is processed, stored, or transmitted by the information system, or that constitutes a violation or imminent threat of violation of security policies, security procedures, or acceptable use policies.

Embodiments of the present invention address the aforementioned unique challenges by providing a cyber threat defense technique that automates the generation of playbooks based on network context and capabilities available to the SOAR platform, where the automated technique is utilized before humans become involved in addressing the cyber threat.

A SOAR platform harnesses various data points to dynamically define playbooks “on the fly” based on the available defenses, countermeasures, environmental context, and nature of the threat. This “on the fly” technique allows a system to define playbooks without requiring a manual definition and implementation of playbooks. In one embodiment, a SOAR capability automatically consumes network context in the form of defense capabilities and this information is overlaid with a Tactics, Techniques, and Procedures (TTP)-based incident type matrix, thereby automatically deploying defenses on incident creation based on the TTP indicators present in the incident. A TTP specifies the behavior of an individual or group posing a cyber threat. A tactic in a TTP is the highest-level description of the behavior. Techniques in a TTP provide a more detailed description of the behavior for a particular tactic. Procedures in a TTP provide the lowest-level, highly detailed description of the behavior in the context of a particular technique. In one embodiment, a TTP specifies the behavior as a series of actions performed in a specific order.

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

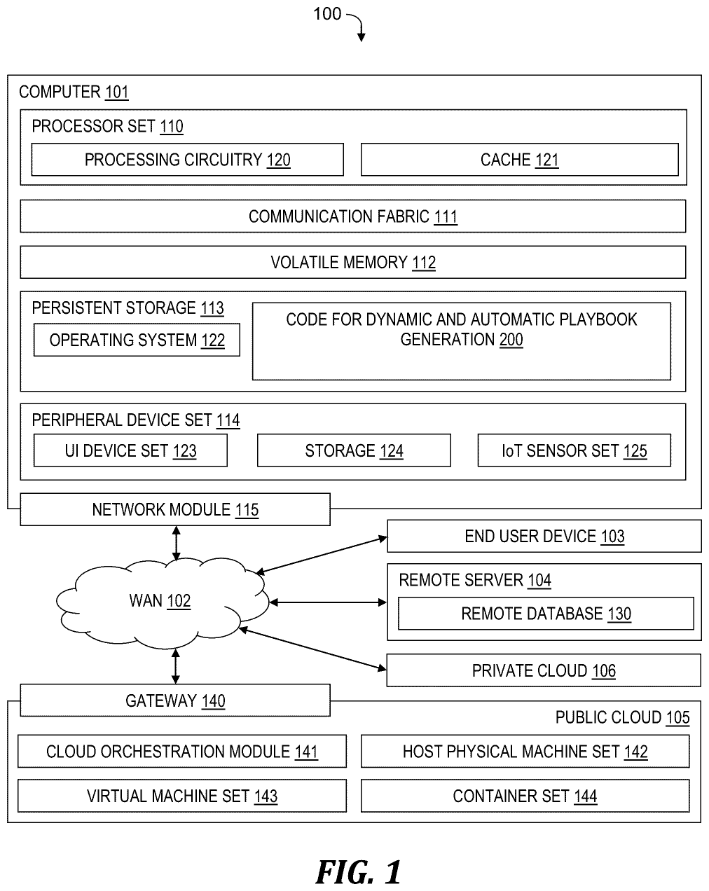

FIG. 1 is a block diagram of a system for dynamic and automatic playbook generation using contextual network responses, in accordance with embodiments of the present invention.

Computing environment 100 contains an example of an environment for the execution of at least some of the computer code involved in performing the inventive methods, such as code 200 for dynamic and automatic playbook generation using contextual network responses. The aforementioned computer code is also referred to herein as computer readable code, computer readable program code, and machine readable code. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### System and Process for Dynamic and Automatic Playbook Generation

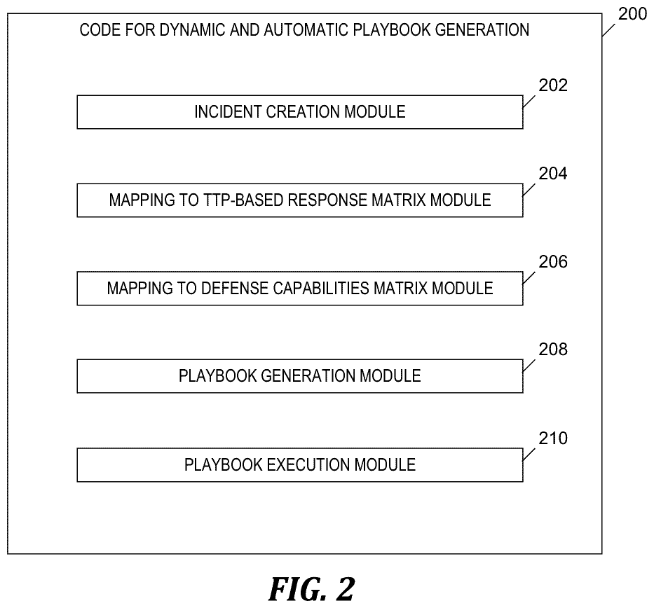

FIG. 2 is a block diagram of modules included in code included in the system of FIG. 1, in accordance with embodiments of the present invention. Code 200 includes an incident creation module 202, a mapping to TTP-based response matrix module 204, a mapping to defense capabilities matrix module 206, a playbook generation module 208, and a playbook execution module 210. Incident creation module 202 is configured to create a new incident and identify the TTP specifying the new incident.

Mapping to TTP-based response matrix module 204 is configured to use a TTP-based response matrix to map the TTP that specifies the incident to action(s) required to respond to or counter the incident. The action(s) required to respond to the incident are also referred to herein as the required action(s).

Mapping to defense capabilities matrix module 206 is configured to use the defense capabilities matrix to map the required actions to available technologies that can perform the required actions.

Playbook generation module 208 is configured to automatically generate a response, which is a playbook that specifies steps for responding to the incident.

Playbook execution module 210 is configured to execute the steps specified by the playbook.

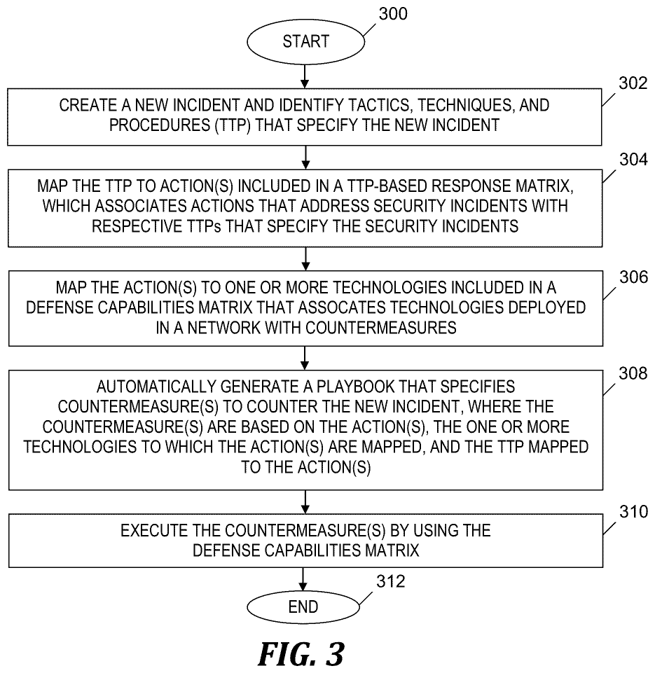

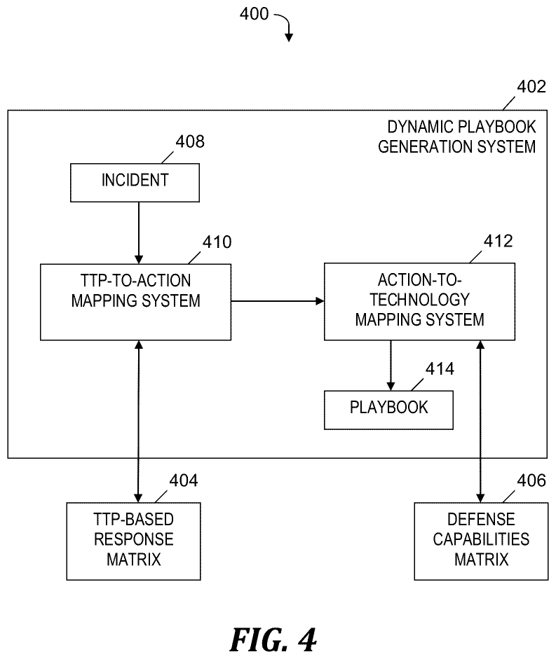

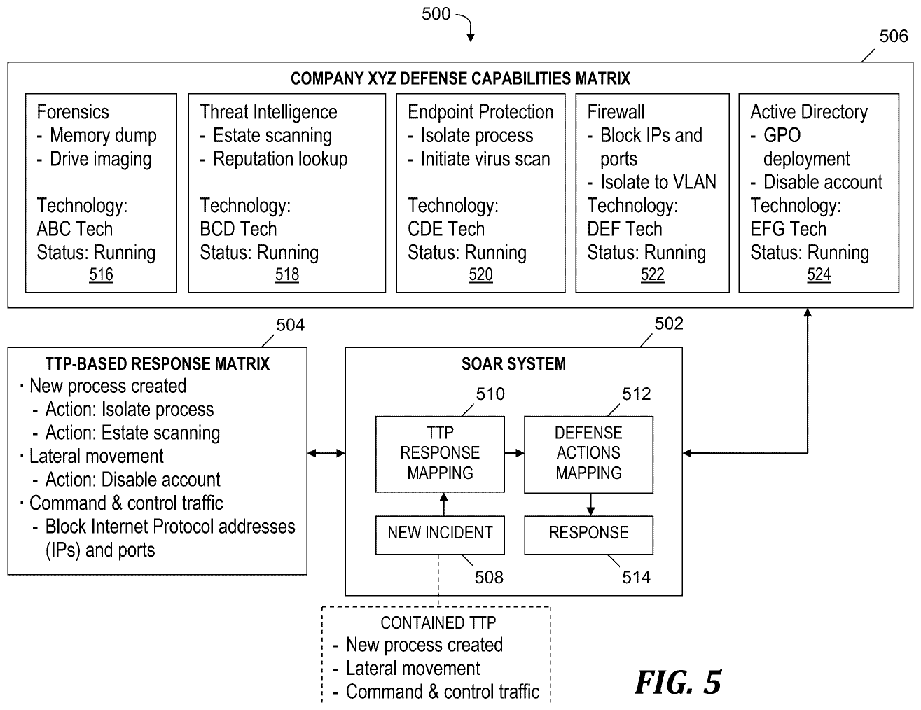

The functionality of the modules included in code 200 is described in more detail in the discussions presented below relative to FIG. 3, FIG. 4, and FIG. 5.

FIG. 3 is a flowchart of a process of dynamic and automatic playbook generation using contextual network responses, where operations of the flowchart are performed by the modules in FIG. 2, in accordance with embodiments of the present invention. The process of FIG. 3 begins at a start node 300. In step 302, incident creation module 202 creates a new incident and identifies TTP that specify the new incident.

In step 304, mapping to TTP-based response matrix module 204 maps the TTP identified in step 302 to action(s) included in a TTP-based response matrix, which associates actions that address security incidents with respective TTPs that specify the security incidents. As used herein, an action that addresses an incident is a countermeasure that responds to or counters the incident. The TTP-based response matrix can be populated by known techniques and frameworks for detecting TTPs.

In step 306, mapping to defense capabilities matrix module 206 maps the action(s) referred to in step 304 to one or more technologies, respectively, included in a defense capabilities matrix, which associates technologies deployed in a network by an organization with countermeasures that counter security incidents. As used herein, an action or countermeasure that counters an incident is defined as an action that reduces a vulnerability of an information system, where the incident exploits or potentially exploits that vulnerability.

In one embodiment, the defense capabilities matrix identifies the capabilities available to an organization and allows a SOAR platform to acquire a contextual understanding of an information system or network. For example, the defense capabilities matrix allows the SOAR platform to know about (i) the availability of a specific technology that implements an endpoint protection feature that can isolate a process or initiate a virus scan and (ii) the availability of another specific technology that implements a firewall that can block Internet Protocol (IP) addresses and ports.

In step 308, playbook generation module automatically generates a playbook that specifies countermeasure(s) as ordered step(s) that counter the new incident created in step 302. The countermeasure(s) are based on the action(s) referred to in step 304, the one or more technologies to which the action(s) are mapped in step 306, and the TTP which is mapped to the action(s) in step 304.

The generation of the playbook in step 308 is performed in response to a creation of a new incident, without requiring a repetition of processing previous incidents to learn what the responses were to the previous incidents. Therefore, the process of FIG. 3 does not require machine learning.

In step 310, playbook execution module 210 executes the countermeasure(s) specified by the playbook generated in step 308. The countermeasure(s) are executed in step 310 by using the one or more technologies referred to in step 306 to perform the countermeasure(s), where the one or more technologies are identified via the defense capabilities matrix.

In one embodiment, step 308 includes generating the playbook dynamically so that the execution of the countermeasure(s) in step 310 does not use or require a static playbook. Following step 310, the process of FIG. 3 ends at an end node 312.

In one embodiment, the process of FIG. 3 further includes a SOAR platform (i) building a contextual understanding of the network and capabilities of the network by identifying assets available on the network by using input from an external source, such as entries in an asset database in a side-channel repository or a Security Information and Event Management (SIEM) platform; and (ii) in response to building the contextual understanding, automatically extending the defense capabilities of the SOAR platform. As additional capabilities are added to the network via new technologies and/or additional technologies, the SOAR platform (i) receives input from the external source about the additional capabilities and the new and/or additional technologies and (ii) dynamically updates the defense capabilities matrix accordingly.

In one embodiment, the process of FIG. 3 further includes (i) a SOAR platform identifying capabilities provided by technologies which are deployed in the network by the organization and are included in the defense capabilities matrix; and (ii) based on the identified capabilities, providing the SOAR platform with a knowledge of (1) an antivirus platform and scanning capabilities provided by the antivirus platform; (2) an endpoint detection and response (EDR) platform and capabilities provided by the EDR platform, including blocking files from being executed and isolating assets from accessing other assets on the network; (3) a firewall and capabilities provided by the firewall, including blocking connections and ports to the internet or different segments of the network; and (4) an active directory and capabilities provided by the active directory, including disabling accounts, resetting passwords, and deploying updated defensive Group Policy Object (GPO) policies.

In one embodiment, the process of FIG. 3 further includes (i) a SOAR platform overlaying the TTP-based response matrix with the defense capabilities matrix; and (ii) based on the TTP-based response matrix being overlaid with the defense capabilities matrix, providing the SOAR platform with a knowledge of: (1) defenses the SOAR platform can deploy automatically and without human intervention in response to a cyber attack; (2) incident types that can be defended against based on a maturity scale; and (3) playbooks that can be automatically built and integrated into, and that are aligned to the TTP-based response matrix. A maturity scale is a measure of available capabilities for addressing a particular type of incident, where the available capabilities are defined by the defense capabilities matrix. For example, as a customer acquires additional technologies, the number of available capabilities increases in the defense capabilities matrix and therefore, the SOAR platform's maturity increases on the maturity scale and additional types of incidents can be defended against by the technologies and capabilities specified in the defense capabilities matrix.

In one embodiment, the process of FIG. 3 further includes (i) a SOAR platform aligning a type of the new incident to the TTP-based response matrix; and (ii) in response to the aligning of the type of the new incident to the TTP-based response matrix, providing the SOAR platform with a knowledge of workings of the type of the new incident and action(s) to defend against the type of the new incident.

In one embodiment, the process of FIG. 3 further includes a SOAR platform performing automated defensive measures to counter the new incident by deploying a dynamic playbook without requiring human intervention, where the automatically generating the playbook in step 308 includes generating the dynamic playbook using the TTP and based on a contextual understanding of the network provided by the defense capabilities matrix.

FIG. 4 is a block diagram of a system 400 that implements the process of FIG. 3, in accordance with embodiments of the present invention. System 400 includes a dynamic playbook generation system 402, TTP-based response matrix 404, and a defense capabilities matrix 406. Dynamic playbook generation system 402 includes an incident 408, a TTP-to-action mapping system 410, an action-to-technology mapping system 412, and a playbook 414.

Dynamic playbook generation system 402 creates an incident 408 and identifies TTP that specify incident 408. In one embodiment, the creation of incident 408 and the identification of the aforementioned TTP are included in step 302.

TTP-to-action mapping system 410 maps the TTP to action(s) that are required to counter incident 408 by using the associations between TTPs and actions included in TTP-based response matrix 404. In one embodiment, the mapping of the TTP to the action(s) is included in step 304.

Action-to-technology mapping system 412 maps the action(s) to which the TTP is mapped to one or more technologies, respectively, by using the associations between countermeasures and technologies included in defense capabilities matrix 406. In one embodiment, the mapping of the action(s) to the one or more technologies is included in step 306.

Dynamic playbook generation system 402 automatically and dynamically generates a playbook that specifies countermeasure(s) to counter incident 408. The countermeasure(s) are based on the action(s) to which the TTP is mapped in step 304, the one or more technologies to which the action(s) are mapped in step 306, and the TTP that is mapped to the action(s) in step 304. In one embodiment, the automatic and dynamic generation of the playbook is included in step 308.

Using the aforementioned one or more technologies which are identified in defense capabilities matrix 406, dynamic playbook generation system 402 executes the playbook (i.e., performs the specific countermeasure(s) that are specified by the playbook). In one embodiment, the execution of the playbook is included in step 310.

In one embodiment, dynamic playbook generation system 402 is implemented in a SOAR platform.

### Example

FIG. 5 is an example 500 of the system of FIG. 4 implementing the process of FIG. 3, in accordance with embodiments of the present invention. Example 500 includes a SOAR system (i.e., a SOAR platform), a TTP-based response matrix 504, and Company XYZ defense capabilities matrix 506. TTP-based response matrix 504 is an example of TTP-based response matrix 404 and Company XYZ defense capabilities matrix 506 is an example of defense capabilities matrix 406. SOAR system 502 includes a new incident 508, TTP response mapping 510, defense actions mapping 512, and a response 514. Company XYZ defense capabilities matrix 506 includes entries for forensics 516, threat intelligence 518, endpoint protection 520, firewall 522, and active directory 524. Each entry in Company XYZ defense capabilities matrix 506 includes an identification of defensive countermeasures that are available by using specific technologies, which are deployed by an organization.

In step 302, SOAR system 502 creates new incident 508 and identifies the TTP that specifies new incident 508: (i) new process created, (ii) lateral movement, and (iii) command & control traffic. SOAR system 502 includes dynamic playbook generation system 402.

In step 304, TTP response mapping 510 maps the TTP that specifies new incident 508 to actions required to counter new incident 508 (hereinafter referred to as the required actions). In one embodiment, TTP response mapping 510 is performed by TTP-to-action mapping system 410 and uses TTP-based response matrix 504.

In step 306, defense actions mapping 512 maps the required actions to available technologies by using Company XYZ defense capabilities matrix 506. In one embodiment, defense actions mapping 512 is performed by action-to-technology mapping system 412.

In step 308, by using the TTP that specifies new incident 508, the TTP response matrix 504, and the Company XYZ defense capabilities matrix 506, SOAR system 502 automatically and dynamically generates a response, which is a playbook that specifies a sequence of countermeasures to perform in order to counter the negative security-related effects that are caused or could potentially be caused by new incident 508.

As one example, response 514 includes a first step of “Isolate process” performed by the technology “CDE Tech” because the first part of the TTP that specifies new incident 508 is “New process created,” TTP-based response matrix 504 associates “New process created” with two actions, and the first of the two actions is “Isolate process,” and the endpoint protection 520 entry in Company XYZ defense capabilities matrix 506 associates “Isolate process” with the technology called “CDE Tech.”

As another example, response 514 includes a second step of “Estate scanning” performed by the technology “BCD Tech” because the first part of the TTP that specifies new incident 508 is “New process created,” TTP-based response matrix 504 associates “New process created” with two actions and the second of the two actions is “Estate scanning,” and the threat intelligence 518 entry in Company XYZ defense capabilities matrix 506 associates “Estate scanning” with the technology called “BCD Tech.”

The descriptions of the various embodiments of the present invention have been presented herein for purposes of illustration but are not intended to be exhaustive or limited to the embodiments disclosed. Many modifications and variations will be apparent to those skilled in the art. Accordingly, the appended claims are intended to encompass all such modifications and variations as fall within the true spirit and scope of the embodiments described herein.

What is claimed is:

1. A computer system comprising:
one or more computer processors;
one or more computer readable storage media; and
computer readable code stored collectively in the one or more computer readable storage media, with the computer readable code including data and instructions to cause the one or more computer processors to perform at least the following operations:
identifying a new incident and the tactics, techniques, and procedures (TTP) that specify the new incident;
mapping the TTP to actions included in a TTP-based response matrix, wherein the TTP-based response matrix associates a plurality of actions with respective TTPs that specify security incidents, and wherein the plurality of actions is required to address the security incidents;
mapping the actions to technologies included in a defense capabilities matrix, wherein the defense capabilities matrix associates a plurality of technologies deployed in a network by an organization with a plurality of countermeasures;
automatically generating a playbook that specifies one or more countermeasures to counter the new incident, the one or more countermeasures being based on the actions, the technologies to which the actions are mapped, and the TTP mapped to the actions; and
executing the one or more countermeasures by using the defense capabilities matrix.

2. The computer system of claim 1, wherein the computer readable code including the data and the instructions causes the one or more computer processors to perform the following further operations:
building a contextual understanding of the network and capabilities of the network by identifying assets available on the network by using an asset database in a side-channel repository or a Security Information and Event Management (SIEM) platform; and
in response to the building the contextual understanding, automatically extending defense capabilities of a Security Orchestration, Automation, and Response (SOAR) platform.

3. The computer system of claim 1, wherein the computer readable code including the data and the instructions causes the one or more computer processors to perform the following further operations:
identifying capabilities provided by the plurality of technologies; and
based on the identified capabilities, providing a Security Orchestration, Automation, and Response (SOAR) platform with a knowledge of (i) an antivirus platform and scanning capabilities provided by the antivirus platform, (ii) an endpoint detection and response (EDR) platform, and capabilities provided by the EDR platform, including blocking files from executing, and isolating assets from accessing other assets on the network, (iii) a firewall and capabilities provided by the firewall, including blocking connections and ports to the internet or different segments of the network, and (iv) an Active Directory and capabilities provided by the Active Directory, including disabling accounts, resetting passwords, and deploying updated defensive Group Policy Object (GPO) policies.

4. The computer system of claim 1, wherein the computer readable code including the data and the instructions causes the one or more computer processors to perform the following further operations:
overlaying, by a Security Orchestration, Automation, and Response (SOAR) platform, the TTP-based response matrix with the defense capabilities matrix; and
based on the overlaying of the TTP-based response matrix with the defense capabilities matrix, providing the SOAR platform with a knowledge of:
defenses the SOAR platform can deploy automatically and without human intervention in response to a cyber attack;
incident types that can be defended against based on a maturity scale; and
playbooks that can be automatically built and integrated into, and that are aligned to the TTP-based response matrix.

5. The computer system of claim 1, wherein the computer readable code including the data and the instructions causes the one or more computer processors to perform the following further operations:
aligning, by a Security Orchestration, Automation, and Response (SOAR) platform, a type of the new incident to the TTP-based response matrix; and
in response to the aligning the type of the new incident, providing the SOAR platform with a knowledge of workings of the type of the new incident and one or more actions to defend against the type of the new incident.

6. The computer system of claim 1, wherein the automatically generating the playbook includes generating a dynamic playbook using the TTP and based on a contextual understanding of the network provided by the defense capabilities matrix, and
wherein the computer readable code including the data and the instructions causes the one or more computer processors to perform the following further operation:
performing automated defensive measures to counter the new incident by deploying the dynamic playbook without requiring human intervention.

7. The computer system of claim 1, wherein the automatically generating a playbook generates a playbook dynamically, and wherein the executing the countermeasures does not use or require a static playbook.

8. A computer program product comprising:
one or more computer readable storage media having computer readable program code collectively stored on the one or more computer readable storage media, the computer readable program code being executed by one or more processors of a computer system to cause the computer system to perform at least the following operations:
identifying a new incident and the tactics, techniques, and procedures (TTP) that specify the new incident;
mapping the TTP to actions included in a TTP-based response matrix, wherein the TTP-based response matrix associates a plurality of actions with respective TTPs that specify security incidents, and wherein the plurality of actions are required to address the security incidents;
mapping the actions to technologies included in a defense capabilities matrix, wherein the defense capabilities matrix associates a plurality of technologies deployed in a network by an organization with a plurality of countermeasures;
automatically generating a playbook that specifies one or more countermeasures to counter the new incident, the one or more countermeasures being based on the actions, the technologies to which the actions are mapped, and the TTP mapped to the actions; and
executing the one or more countermeasures by using the defense capabilities matrix.

9. The computer program product of claim 8, wherein the computer readable program code being executed by the one or more processors of the computer system causes the computer system to perform the following further operations:
building a contextual understanding of the network and capabilities of the network by identifying assets available on the network by using an asset database in a side-channel repository or a Security Information and Event Management (SIEM) platform; and
in response to the building the contextual understanding, automatically extending defense capabilities of a Security Orchestration, Automation, and Response (SOAR) platform.

10. The computer program product of claim 8, wherein the computer readable program code being executed by the one or more processors of the computer system causes the computer system to perform the following further operations:
identifying capabilities provided by the plurality of technologies; and
based on the identified capabilities, providing a Security Orchestration, Automation, and Response (SOAR) platform with a knowledge of (i) an antivirus platform and scanning capabilities provided by the antivirus platform, (ii) an endpoint detection and response (EDR) platform, and capabilities provided by the EDR platform, including blocking files from executing, and isolating assets from accessing other assets on the network, (iii) a firewall and capabilities provided by the firewall, including blocking connections and ports to the internet or different segments of the network, and (iv) an Active Directory and capabilities provided by the Active Directory, including disabling accounts, resetting passwords, and deploying updated defensive Group Policy Object (GPO) policies.

11. The computer program product of claim 8, wherein the computer readable program code being executed by the one or more processors of the computer system causes the computer system to perform the following further operations:
overlaying, by a Security Orchestration, Automation, and Response (SOAR) platform, the TTP-based response matrix with the defense capabilities matrix; and
based on the overlaying of the TTP-based response matrix with the defense capabilities matrix, providing the SOAR platform with a knowledge of:
defenses the SOAR platform can deploy automatically and without human intervention in response to a cyber attack;
incident types that can be defended against based on a maturity scale; and
playbooks that can be automatically built and integrated into, and that are aligned to the TTP-based response matrix.

12. The computer program product of claim 8, wherein the computer readable program code being executed by the one or more processors of the computer system causes the computer system to perform the following further operations:
aligning, by a Security Orchestration, Automation, and Response (SOAR) platform, a type of the new incident to the TTP-based response matrix; and
in response to the aligning the type of the new incident, providing the SOAR platform with a knowledge of workings of the type of the new incident and one or more actions to defend against the type of the new incident.

13. The computer program product of claim 8, wherein the automatically generating the playbook includes generating a dynamic playbook using the TTP and based on a contextual understanding of the network provided by the defense capabilities matrix, and
wherein the computer readable program code being executed by the one or more processors of the computer system causes the computer system to perform the following further operation:
performing automated defensive measures to counter the new incident by deploying the dynamic playbook without requiring human intervention.

14. The computer program product of claim 8, wherein the automatically generating a playbook generates a playbook dynamically, and wherein the executing the countermeasures does not use or require a static playbook.

15. A computer-implemented method comprising:
identifying, by one or more processors, a new incident and the tactics, techniques, and procedures (TTP) that specify the new incident;
mapping, by the one or more processors, the TTP to actions included in a TTP-based response matrix, wherein the TTP-based response matrix associates a plurality of actions with respective TTPs that specify security incidents, and wherein the plurality of actions are required to address the security incidents;
mapping, by the one or more processors, the actions to technologies included in a defense capabilities matrix, wherein the defense capabilities matrix associates a plurality of technologies deployed in a network by an organization with a plurality of countermeasures;
automatically generating, by the one or more processors, a playbook that specifies one or more countermeasures to counter the new incident, the one or more countermeasures being based on the actions, the technologies to which the actions are mapped, and the TTP mapped to the actions; and
executing, by the one or more processors, the one or more countermeasures by using the defense capabilities matrix.

16. The method of claim 15, further comprising:
building a contextual understanding of the network and capabilities of the network by identifying assets available on the network by using an asset database in a side-channel repository or a Security Information and Event Management (SIEM) platform; and
in response to the building the contextual understanding, automatically extending defense capabilities of a Security Orchestration, Automation, and Response (SOAR) platform.

17. The method of claim 15, further comprising:
identifying capabilities provided by the plurality of technologies; and
based on the identified capabilities, providing a Security Orchestration, Automation, and Response (SOAR) platform with a knowledge of (i) an antivirus platform and scanning capabilities provided by the antivirus platform, (ii) an endpoint detection and response (EDR) platform, and capabilities provided by the EDR platform, including blocking files from executing, and isolating assets from accessing other assets on the network, (iii) a firewall and capabilities provided by the firewall, including blocking connections and ports to the internet or different segments of the network, and (iv) an Active Directory and capabilities provided by the Active Directory, including disabling accounts, resetting passwords, and deploying updated defensive Group Policy Object (GPO) policies.

18. The method of claim 15, further comprising:
overlaying, by a Security Orchestration, Automation, and Response (SOAR) platform, the TTP-based response matrix with the defense capabilities matrix; and
based on the overlaying of the TTP-based response matrix with the defense capabilities matrix, providing the SOAR platform with a knowledge of:
defenses the SOAR platform can deploy automatically and without human intervention in response to a cyber attack;
incident types that can be defended against based on a maturity scale; and
playbooks that can be automatically built and integrated into, and that are aligned to the TTP-based response matrix.

19. The method of claim 15, further comprising:
aligning, by a Security Orchestration, Automation, and Response (SOAR) platform, a type of the new incident to the TTP-based response matrix; and
in response to the aligning the type of the new incident, providing the SOAR platform with a knowledge of workings of the type of the new incident and one or more actions to defend against the type of the new incident.

20. The method of claim 15, further comprising:
performing automated defensive measures to counter the new incident by deploying a dynamic playbook without requiring human intervention,
wherein the automatically generating the playbook includes generating the dynamic playbook using the TTP and based on a contextual understanding of the network provided by the defense capabilities matrix.
